(19) United States
(12) Patent Application Publication
(10) Pub. No.: US 2024/0351575 A1
(43) Pub. Date: Oct. 24, 2024

(54) METHOD FOR AUTOMATICALLY ADAPTING A TRACTION CONTROL OF A VEHICLE

(71) Applicant: Robert Bosch GmbH, Stuttgart (DE)

(72) Inventors: Jonas Krause, Waldbach (DE); Marco Stumm, Ahrensburg (DE); Michael Erden, Bietigheim-Bissingen (DE); Rami Scharbak, Benningen (DE)

(21) Appl. No.: 18/681,936

(22) PCT Filed: Sep. 20, 2022
(86) PCT No.: PCT/EP2022/076009

§ 371 Date: Feb. 7, 2024

(30) Foreign Application Priority Data
Oct. 18, 2021 (DE) 10 2021 211 740.6

(51) Int. Cl. B60W 30/02; B60W 10/04; B60W 10/18

(52) U.S. Cl. CPC B60W 30/02; B60W 10/04; B60W 10/18; B60W 2520/26

(57) ABSTRACT

A method for automatically adapting a traction control of a vehicle. The method includes: receiving current state variables of the vehicle, each of which indicates a current state of the vehicle; determining a control action using a traction controller based on the received current state variables, wherein the control action includes increasing, maintaining, or decreasing a control variable including a torque of a motor and/or a pressure of a brake cylinder; determining a control gradient of the control variable using a value matrix which includes a plurality of parameters each assigned to current value matrix state variables of the vehicle, wherein the control gradient is selected from the plurality of parameters as a function of the current value matrix state variables which include the current value matrix state variables; carrying out the traction control of the vehicle.

### FIELD

The present invention relates to a method for automatically adapting a traction control of a vehicle, and to a device for this purpose.

### BACKGROUND INFORMATION

Modern vehicles comprise a traction control or drive traction control as a function module of an electronic stability program, ESP, system. The term “traction control” is used below synonymously with the term “drive traction control” and can also be replaced by this term. The traction control is carried out by a traction control system, TCS. The functional purpose of the TCS is that the wheels do not spin during the longitudinal start of a vehicle and that vehicle requirements with regard to stability, steerability and traction are thus met. According to a conventional controller strategy, a physically based actuator setpoint value (motor/brake) is to be able to optimally compensate for corresponding driving situations. Detections, estimations and models are necessary for the setpoint value determination. Controller parameters serve for ideally approaching the setpoint value and must be determined manually/by hand by an application engineer.

However, current controllers for TCS are designed for applications by persons. This is associated with a comparatively high expenditure of time and thus of costs. In addition, a person has a non-objective, personal influence on the performance of the TCS. In addition, it has been shown that conventional controller strategies with contrary targets for different maneuvers/grounds encounter difficulties in finding an optimum. Finally, the driving dynamic of the vehicle is strongly influenced by the variant of the vehicle. An optimal application would thus require the availability of each vehicle variant.

### SUMMARY

There is a need for a traction control of a vehicle that adapts automatically.

According to one aspect of the present invention, a method for automatically adapting a traction control of a vehicle is provided. According to an example embodiment of the present invention, in one step, current state variables of the vehicle, which respectively indicate a current state of the vehicle, are received. In a further step, a control action is determined by a traction controller on the basis of the received current state variables, wherein the control action comprises increasing, maintaining, or decreasing a control variable, wherein the control variable comprises a torque of a motor of the vehicle and/or a pressure of a brake cylinder of the vehicle. In a further step, a control gradient of the control variable is determined using a value matrix, wherein the value matrix comprises a plurality of parameters, which are each assigned to current value matrix state variables of the vehicle, wherein the control gradient is selected from the plurality of parameters as a function of the current value matrix state variables, wherein the current state variables comprise the current value matrix state variables. In a further step, the traction control of the vehicle is carried out, wherein the control variable is adapted by the determined control gradient according to the determined control action. In a further step, a change in the current state variables as a result of carrying out the traction control is determined over a considered time period. In a further step, at least one parameter of the value matrix is adapted as a function of the determined change in the current state variables by triggering at least one previously specified learning rule.

The term “state variables” as used herein describes variables which contain information about a state of the vehicle. The state variables are preferably provided by sensors of the vehicle. The state variables preferably comprise a slip, a wheel acceleration, a torque of the motor, a pressure of a brake cylinder, a brake pedal position, or the pedal displacement covered, a steering angle of the vehicle, a lateral acceleration of the vehicle, and a speed of the vehicle.

The term “value matrix state variables” as used herein describes a set of state variables of the vehicle which are mapped by the value matrix. In other words, the value matrix state variables comprise those state variables of the vehicle to which parameters are assigned by the value matrix, on the basis of which parameters the control gradient is in turn determined.

The term “control gradient” as used herein refers to a gradient applied to the control variable. In other words, the control gradient specifies by which variable the control variable is to change as a result of the traction control.

The term “control variable” as used herein refers to a variable to be controlled by the traction control. During the traction control, the attempt is preferably made to reduce the slip by controlling the motor of the vehicle and/or the brakes of the vehicle. Thus, the control variables, i.e., the variables that are to be controlled, are presented as a torque of the motor of the vehicle and/or as a pressure of the brake cylinder of the vehicle.

The term “learning rule” as used herein refers to a rule that defines how, on the basis of the current state variables of the vehicle, one or more parameters of the value matrix are to be changed, in particular at the amount of a so-called learning value. In other words, the learning rule represents a function of current state variables and learning value.

The term “value matrix” as used herein generally refers to an assignment of at least one output value to at least one input value. In this case, the input values are current state variables of the vehicle, which are referred to herein as value matrix state variables. In other words, the value matrix assigns at least one output value to each combination of input values. The value matrix thus comprises a plurality of parameters, wherein each parameter is assigned to a combination of current state variables of the vehicle. The parameter of the plurality of parameters of the value matrix that is assigned to the combination of current state variables provided to the value matrix as input represents the so-called control gradient. The control gradient is thus the output of the value matrix and thus the parameter on the basis of which the control variable is changed during the traction control. A separate value matrix is preferably provided for each control action. In other words, a different value matrix is provided for increasing a control variable than for decreasing the same control variable.

For example, six value matrices are thus implemented in a vehicle with a rear drive. Specifically, a first value matrix for increasing the motor torque of the motor, a second value matrix for decreasing the motor torque of the motor, a third value matrix for increasing the pressure of the brake cylinder of the first rear wheel of the vehicle, a fourth value matrix for decreasing the pressure of the brake cylinder of the first rear wheel of the vehicle, a fifth value matrix for increasing the pressure of the brake cylinder of the second rear wheel of the vehicle, and a sixth value matrix for decreasing the pressure of the brake cylinder of the second rear wheel of the vehicle.

If the vehicle has a plurality of motors, such as in the case of wheel hub motors, the number of value matrices for the motor controller is multiplied accordingly, i.e., for each motor, a value matrix for increasing the torque and a value matrix for decreasing the torque.

The same applies to the number of driven wheels/axles. In other words, two value matrices are assigned to each wheel with a brake, one value matrix for increasing the brake torque and one value matrix for decreasing the brake torque.

According to an example embodiment of the present invention, different value matrices are preferably used if the corresponding controller requires an amplification of the current control or an attenuation of the current control. For example, two different value matrices each (increasing and decreasing the torque) are used in the event that the controller requires a build-up of the torque, wherein the torque is currently falling, and in the event that the controller requires a build-up of the torque, wherein the torque is currently rising.

According to an example embodiment of the present invention, the time period to be considered preferably comprises a time period of 200 ms. The time period to be considered in which a change in the current state variables as a result of carrying out the traction control is considered can be different for each learning rule.

For example, the traction controller is optimized to a great extent even during a test phase, i.e., the parameters of the value matrix are adapted. Thus, for example, 90% of the optimization can be carried out even before the vehicle is delivered, and the remaining 10% can then be optimized later during operation of the vehicle.

In this way, the traction control is set by an automatic algorithm on the basis of learning rules.

The provided method according to the present invention introduces objective rules for optimizing the traction control, whereby human influence is minimized.

In addition, the provided method according to the present invention enables rapid individual adaptation of the traction controller to different vehicle variants.

Since the know-how is mainly in the traction controller that carries out the provided method according to the present invention, less highly qualified personnel are necessary in order to optimize the traction control.

Finally, the provided method according to the present invention allows a traction control to be optimized with comparatively little time expenditure.

In a preferred embodiment of the present invention, the current value matrix state variables of the vehicle comprise a slip and a wheel acceleration of the vehicle.

The value matrix preferably comprises a two-dimensional value matrix, i.e., a value matrix that assigns one parameter to a combination of two input values. For example, the value matrix assigns in each case one parameter, which in particular specifies a control gradient, to a plurality of combinations of slips and wheel accelerations of the vehicle.

In principle, three- or multi-dimensional value matrices are also possible, wherein a two-dimensional value matrix represents a preferred weighing up of complexity of the value matrix and performance influence on the traction control.

In a preferred embodiment of the present invention, at least one learning rule is triggered in the considered time period by the determined change in the current state variables by a previously specified limit value, wherein the learning rule determines a learning value by which the at least one parameter is adapted.

In other words, the learning rule comprises a limit value for each state variable to be checked, in particular a lower limit value and an upper limit value. If the limit value for the respective state variable is exceeded, or undershot, the learning rule is carried out or in other words is triggered. According to the condition defined by the learning rule, the learning rule outputs a learning value by which at least one parameter of the value matrix is to be changed.

The term “learning value” as used herein represents a value by which at least one parameter of the value matrix is to be changed. Preferably, the learning value is previously specified as a value of 10%. In other words, a learning value of 10% means increasing or decreasing the at least one parameter of the value matrix by 10% of the current value of the respective parameter. The learning value preferably comprises information as to whether the parameters are increased or decreased by the specified value.

According to an example embodiment of the present inventon, preferably, the at least one learning rule is part of a machine learning model, wherein the machine learning model comprises a reinforcement learning model, wherein the current situation is considered and a preceding action of the controller is evaluated. The machine learning model is preferably configured to adapt the at least one learning rule according to the determined change in the current state variables. In particular, adapting the at least one learning rule comprises adapting a previously specified limit value and/or learning value.

In a preferred embodiment of the present invention, the previously specified learning value is adapted as a function of a wheel acceleration of the vehicle.

The wheel acceleration is also referred to as wheel dynamic or axle dynamic.

According to an example embodiment of the present invention, preferably, a range of the learning value in which the learning value can be adapted is between 5% and 30%. A learning value that is too small can lead to an unnecessarily high number of iterations being required for learning, since the change in the driving behavior is small. A learning value that is too large can lead to the optimum of the control not being able to be set precisely, since the percentage change prevents the latter.

It has been found that, in the case of an original specification of the learning value as 10%, a dependence of the learning value on the axle dynamic and a variable amount of the learning value of 5-30% results in better and faster results during learning.

For example, a learning rule states that, in the case of an axle dynamic of −2.75, i.e., a medium deceleration of the axle, a change in the parameters with a learning value of 20% is triggered.

For example, a further learning rule states that, in the case of an axle dynamic of 1.5, i.e., a slight acceleration of the axle, a change in the parameters with a learning value of −15% is triggered.

In a preferred embodiment of the present invention, the learning rules comprise adjustment learning rules and control learning rules, wherein the adjustment learning rules are applied during an adjustment phase of the slip and the control learning rules are applied during the control after the adjustment phase of the slip.

Preferably, according to an example embodiment of the present invention, adjustment learning rules consider only the entire adjustment behavior of the traction control. Like any controller, the traction control also has an adjustment behavior which as a rule differs from the further control behavior of the controller. For this reason, special adjustment learning rules are used for the adjustment behavior. Preferably, the adjustment behavior is defined as a time range of the traction control until the slip to be controlled has passed a target slip after application of the first learning rule. Alternatively, the adjustment behavior is defined as a time range before the slip remains near a target value for a previously specified amount of time. Furthermore alternatively, the adjustment behavior is defined as a time range in which the oscillation of the slip about the target value undershoots a previously specified limit value. For example, as a result of the initial traction control, the slip falls below a minimum limit value of the target slip that triggers a learning rule. As soon as the slip has passed a maximum limit value of the target slip due to the traction control, the adjustment phase ends and the actual control of the slip begins.

An example of an adjustment learning rule is in a so-called “OnRef” situation in the adjustment phase in which an axle is no longer in drive slip. Consequently, the controller has decreased the slip too much. The adjustment learning rule consequently adapts the value matrix for decreasing the motor torque and the value matrix for increasing the brake pressure in such a way that the parameters of the value matrices are decreased by 10%, i.e., the learning value is −10%. During the next time in this state, the reduction in the parameter value is to prevent a slip that is too low. Furthermore, the learning rule adapts the value matrix for increasing the motor torque and the value matrix for decreasing the brake pressure in such a way that the parameters of the value matrices are increased by 10%, i.e., the learning value is 10%. During the next time in this state, the increase in the parameter value is to prevent a slip that is too low.

A further example of an adjustment learning rule is a situation in which the wheel dynamic, i.e., the wheel acceleration, was decreased for a defined time span, for example 80 ms, and then increased without the target slip having been reached. The adjustment learning rule consequently adapts the value matrix for decreasing the motor torque and the value matrix for increasing the brake pressure in such a way that the parameters of the value matrices are increased by 10%, i.e., the learning value is 10%. During the next time in this state, the increase in the parameter value is to permanently prevent a slip that is too high. Furthermore, the learning rule adapts the value matrix for increasing the motor torque and the value matrix for decreasing the brake pressure in such a way that the parameters of the value matrices are decreased by 10%, i.e., the learning value is −10%. During the next time in this state, the decrease in the parameter value is to allow a lower slip to be achieved during the start.

A further example of an adjustment learning rule is a situation in which the wheel dynamic, i.e., the wheel acceleration, is not decreased for a defined time span, for example 200 ms. The adjustment learning rule consequently adapts the value matrix for decreasing the motor torque and the value matrix for increasing the brake pressure in such a way that the parameters of the value matrices are increased by 10%, i.e., the learning value is 10%. During the next time in this state, the increase in the parameter value is to permanently prevent a slip that is too high.

According to an example embodiment of the present invention, preferably, a change in the current state variables as a result of carrying out the traction control in the adjustment phase is determined and thus evaluated over the entire adjustment phase. Less recent controls, in other words action phases, can thus also be considered and learned. For example, an increase phase is very large so that the motor cannot follow. Consequently, a prior decrease phase is also adapted.

An example of a control learning rule is a situation in which a minimum limit value of the slip target, in particular less than 3.5% slip as the target, is undershot in a time range to be observed. The control learning rule consequently adapts the value matrix for increasing the motor torque and the value matrix for decreasing the brake pressure in such a way that the parameters of the value matrices are increased by 10%, i.e., the learning value is 10%. During the next time in this state, the increase in the parameter value is to prevent a slip that is too low, since the last control action, when it was to increase the slip, did not increase the slip enough. Alternatively, the control learning rule adapts consequently adapts the value matrix for decreasing the motor torque and the value matrix for increasing the brake pressure in such a way that the parameters of the value matrices are decreased by 10%, i.e., the learning value is −10%. During the next time in this state, the decrease in the parameter value is to prevent a slip that is too low, since the last control action, when it was to decrease the slip, decreased the slip too much.

A further example of a control learning rule is a situation in which a maximum limit value, in particular over 7% slip, is exceeded. The control learning rule consequently adapts the value matrix for increasing the motor torque and the value matrix for decreasing the brake pressure in such a way that the parameters of the value matrices are decreased by 10%, i.e., the learning value is −10%. During the next time in this state, the decrease in the parameter value is to prevent a slip that is too high, since the last control action, when it was to increase the slip, increased the slip too much. Alternatively, the control learning rule consequently adapts the value matrix for decreasing the motor torque and the value matrix for increasing the brake pressure in such a way that the parameters of the value matrices are increased by 10%, i.e., the learning value is 10%. During the next time in this state, the increase in the parameter value is to prevent a slip that is too high, since the last control action, when it was to decrease the slip, did not decrease the slip enough.

A further example of a control learning rule is a situation in which a slip state, i.e., a current slip above the maximum limit value of the target slip or a current slip below the minimum limit value of the target slip, remains unchanged in a considered time period. This indicates too small a change in the desired action of the controller, i.e., the build-up or reduction of the slip, as a result of which the vehicle is not controlled well. Consequently, a control learning rule will increase the corresponding parameters of the value matrix.

A further example of a control learning rule is the general desire to prevent the motor from stalling at a rotational speed that is too low, for example at 1200 rpm. On the basis of the state variable “rotational speed of the motor,” the control learning rule consequently adapts the value matrix for decreasing the motor torque and the value matrix for increasing the brake pressure in such a way that the parameters of the value matrices are decreased by 10%, i.e., the learning value is −10%. During the next time in this state, the decrease in the parameter value is to avoid a rotational speed that is too low, since the last control action has decreased the rotational speed too much. Alternatively, the control learning rule adapts the value matrix for increasing the motor torque and the value matrix for decreasing the brake pressure in such a way that the parameters of the value matrices are increased by 10%, i.e., the learning value is 10%. During the next time in this state, the increase in the parameter value is to avoid a rotational speed that is too low, since the last control action has decreased the rotational speed too much.

In a preferred embodiment of the present invention, the method comprises the following step: arbitrating at least two temporally successive learning rules if the at least two learning rules fall below a previously specified time interval between them.

More often, a parameter is increased and subsequently decreased, or vice versa. If an increase and a decrease in the parameter occur very closely in time to one another, for example within 150 ms, the first learning would conflict with the second learning. Arbitrating the learning rules must thus be applied for such scenarios.

According to an example embodiment of the present invention, the arbitration comprises ignoring the earlier learning rule since the second learning rule has more current and/or more information. Alternatively, the arbitration comprises ignoring both learning rules. Alternatively, the arbitration comprises applying the temporally first learning rule only to a range that is further away from the triggering of the temporally second learning rule.

Thus, the arbitration of the traction control allows different requirements for maneuvers and/or grounds to be taken into account.

In a preferred embodiment of the present invention, the method comprises the following step: learning a response time between the evaluation of the change in the current state variables and the traction control.

The response time refers to a time delay between an evaluation, i.e., ultimately the triggering of a learning rule, and the respective cause, i.e., a change of a state variable in a time period to be considered. Depending on the vehicle and/or motor variant, the response time is different for optimized traction control.

A response time is preferably determined by specifying a comparatively large target in order to observe when this target is reached by the current motor.

Furthermore preferably, several response times are determined at different rotational speeds of the motor since the motor characteristic can cause different behavior in each case.

In a preferred embodiment of the present invention, the method comprises the following step: ignoring triggered learning rules as a function of the current state variables.

For example, learning rules by 20% around a target zone of a state variable, in particular a target slip or target torque, are ignored.

According to a further aspect of the present invention, a computer program product configured to carry out the method according to the present invention as described herein is provided.

According to a further aspect of the present invention, a device configured to carry out the method according to the present invention as described herein is provided.

Further measures improving the present invention are explained in more detail below, together with the description of the preferred exemplary embodiments of the present invention, with reference to figures.

### BRIEF DESCRIPTION OF THE DRAWINGS

FIG. 1 is a schematic representation of a traction control with value matrices, according to an example embodiment of the present invention.

FIG. 2 is a schematic representation of a two-dimensional value matrix, according to an example embodiment of the present invention.

FIG. 3 is a schematic representation of a plurality of value matrices of a vehicle, according to an example embodiment of the present invention.

FIG. 4 is a schematic representation of a method for adapting a traction control, according to an example embodiment of the present invention.

FIG. 5 is a schematic representation of learning rules in a traction control, according to an example embodiment of the present invention.

FIG. 6 is a schematic representation of a dynamic adaptation of the learning value, according to an example embodiment of the present invention.

FIG. 7 is a schematic representation of an arbitration between learning rules, according to an example embodiment of the present invention.

FIG. 8 is a schematic representation of learning a response time in the traction control, according to an example embodiment of the present invention.

### DETAILED DESCRIPTION OF EXAMPLE EMBODIMENTS

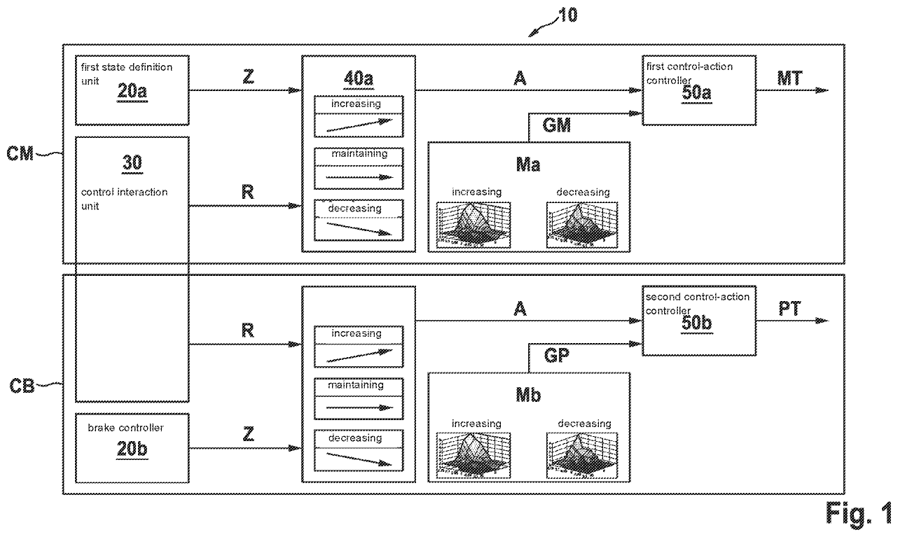

FIG. 1 is a schematic representation of a traction controller 10 with value matrices. The traction controller controls the slip of the vehicle by controlling the control variables of torque of the motor by means of a motor controller CM and of pressure in the brake cylinder by means of a brake controller CB. The traction controller 10 has a first state definition unit 20a in the motor controller CM and a second state definition unit in the brake controller CB 20b, which respectively provide current state variables Z of the vehicle. The state variables Z comprise, for example, a slip S, a motor speed n, an axle dynamic Ya, a current torque of the motor, and a time. In addition, a control interaction unit 30 provides a current control R of the traction controller 10. In particular, the traction controller 10 has a first control-action decision unit 40a in the motor controller CM and a second control-action decision unit 40b in the brake controller CB. The first control-action decision unit 40a and the second control-action decision unit 40b determine a control action A, in particular on the basis of the determined state variables Z and, optionally, the current control R. The control action A comprises either increasing, maintaining, or decreasing the corresponding control variable.

The traction controller 10 also comprises value matrices Ma, Mb in the motor controller CM and in the brake controller CB. A value matrix is provided for each element to be controlled. For example, a value matrix is assigned to a motor and, in the case of a rear wheel drive, a separate value matrix for the respective brake cylinders is respectively assigned to each of the two rear wheels. In this case, three value matrices would be necessary. FIG. 1 shows, in a simplified form, only a first value matrix Ma for the motor controller Cm and a second value matrix Mb for the brake controller. The current state variables Z comprise a slip S and a wheel acceleration Ya. The first value matrix Ma and the second value matrix Mb respectively assign control gradients GM and GP to these two state variables Z. In particular, the first value matrix Ma determines a torque control gradient GM and the second value matrix Mb determines a pressure control gradient GP. The first value matrix Ma and the second value matrix Mb in each case comprise two value matrices which are respectively used for increasing the control variable and decreasing the control variable A.

The traction controller 10 comprises a first control-action controller 50a in the motor controller CM and a second control-action controller 50b in the brake controller CB. The first control-action controller 50a determines a target torque MT on the basis of the determined control action A and the determined torque control gradient GM. The second control-action controller 50b determines a target pressure PT on the basis of the determined control action A and the determined pressure control gradient GP.

In this way, the traction controller 10 controls the motor and/or the brakes of the vehicle using value matrices Ma, Mb in order to achieve a target slip.

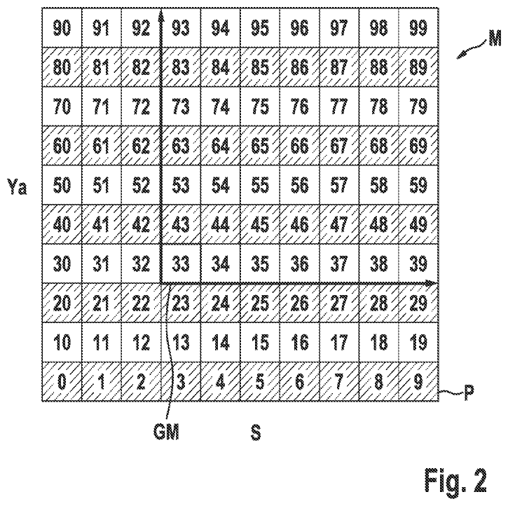

FIG. 2 is a schematic representation of a two-dimensional value matrix M. The value matrix M is a representation of the current slip S of the vehicle over the current wheel acceleration Ya of the vehicle in previously specified discrete steps. In this case, the value matrix M comprises 100 entries, wherein 10 discrete possible slip values S and 10 discrete possible wheel accelerations Ya in every combination are shown. Consequently, a current slip S is assigned to one of the closest entries of the slip in the value matrix. The same applies to the wheel acceleration Ya. Each of these entries of the value matrix M is called parameter P. Each parameter P contains information about a possible control gradient, i.e., a change of at least one control variable. In this case, the value matrix M is used to control a motor torque. A combination of current slip S and current wheel acceleration Ya has been assigned to the parameter 33. The parameter 33 contains information about a change in the motor torque to be controlled, i.e., in other words, the torque control gradient GM.

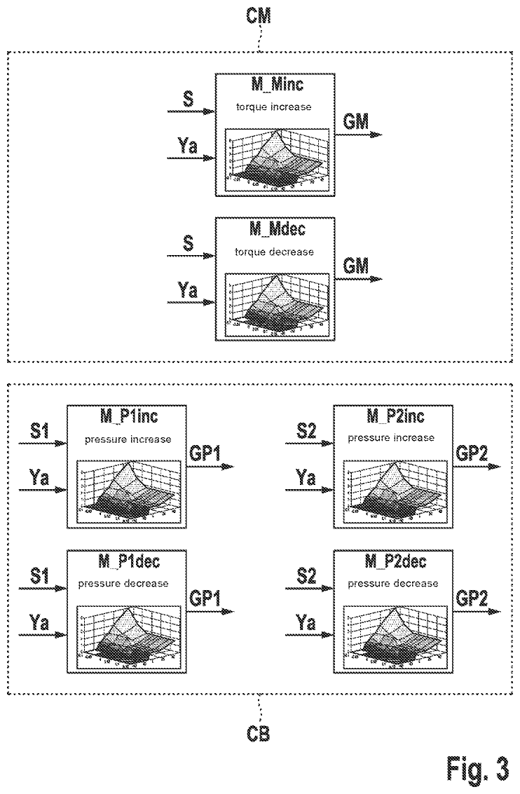

FIG. 3 is a schematic representation of a plurality of value matrices of a vehicle. An example of a vehicle with a motor and a rear-wheel drive is shown.

Consequently, a motor controller CM comprises a first value matrix M_Minc which, in the event of a determined torque increase, assigns a slip S, i.e., a total slip of the vehicle, and a wheel acceleration Ya to a torque control gradient GM. In addition, the motor controller Cm comprises a second value matrix M_Mdec which, in the event of a determined torque decrease, assigns a slip S of the vehicle and a wheel acceleration Ya to a torque control gradient GM.

For the traction control, the rear-wheel drive is to control the two brake cylinders of the respective rear wheels. The brake controller CB thus comprises a third value matrix M_P1inc which, in the event of a determined pressure increase, assigns a slip of the first rear wheel S1 and a wheel acceleration Ya to a first pressure control gradient GP1 for the first rear wheel. In addition, the brake controller CB comprises a fourth value matrix M_P1dec which, in the event of a determined pressure decrease, assigns a slip of the first rear wheel S1 and a wheel acceleration Ya to a first pressure control gradient GP1 for the first rear wheel. In addition, the brake controller CB comprises a fifth value matrix M_P2inc which, in the event of a determined pressure increase, assigns a slip of the second rear wheel S2 and a wheel acceleration Ya to a second pressure control gradient GP2 for the second rear wheel. In addition, the brake controller CB comprises a sixth value matrix M_P2dec which, in the event of a determined pressure decrease, assigns a slip of the second rear wheel S2 and a wheel acceleration Ya to a second pressure control gradient GP2 for the second rear wheel.

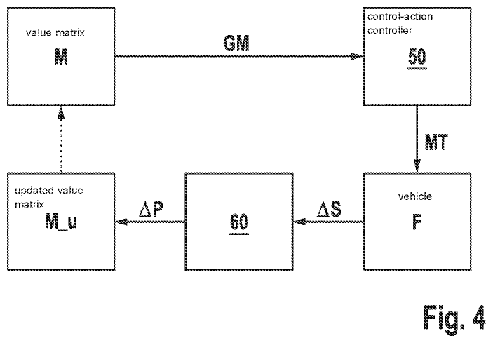

FIG. 4 is a schematic representation of a method for adapting a traction control. In this case, a traction control by controlling the motor torque is shown. As already described, a torque control gradient GM is determined via a value matrix M. On the basis of the torque control gradient GM, a control-action controller 50 determines a target torque toward which the traction controller controls the motor torque. The traction control of the vehicle F is thus carried out, wherein the control variable, in this case the motor torque, is adapted by the determined control gradient GM according to a determined control action. The traction controller then monitors the current state variables S of the vehicle S and determines a change in the current state variables ΔS as a result of carrying out the traction control over a considered time period. A behavior evaluation unit 60 evaluates the change in the current state variables ΔS. In particular, the behavior evaluation unit 60 comprises a plurality of previously determined learning rules which can be triggered as a function of the change in the current state variables ΔS. The individual learning rules determine a learning value ΔP by which the parameters P of the value matrix M are adapted in order to obtain an updated value matrix M_u. In this way, a dynamically learned value matrix can be provided, on the basis of which the traction controller can carry out an optimized traction control.

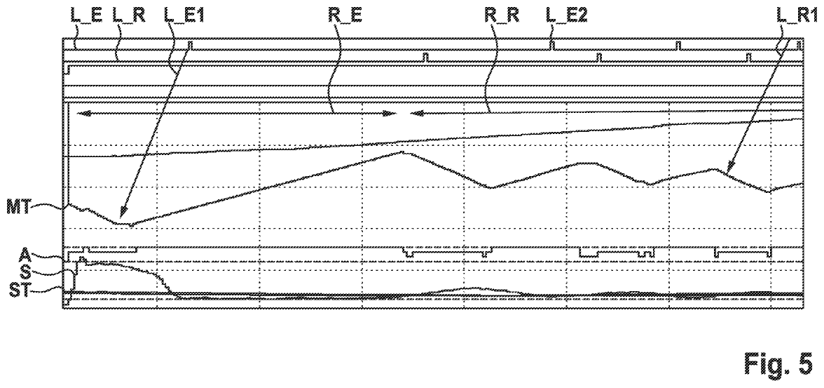

FIG. 5 is a schematic representation of learning rules in a traction control. In particular, FIG. 5 shows a target torque MT of the motor, a control action A, a slip S, and a target slip ST over the time of a traction control. FIG. 5 represents an adjustment behavior with a subsequent normal control. In other words, FIG. 5 shows an adjustment phase R_E and a control phase R_R. For the adjustment phase R_E, different learning rules that can be triggered are provided than for the control phase R_R. Also shown are adjustment learning rules L_E and control learning rules L_R over the time. In the adjustment phase R_E, a first adjustment learning rule L_E1 is triggered, which ensures an increase in the target torque MT. A second adjustment learning rule L_E2 is triggered in the control phase R_R. However, this second adjustment learning rule L_E2 is ignored since it is relevant only in the adjustment phase R_E. In the control phase R_R, only control learning rules L_R are considered. For example, a first control learning rule L_R1 is triggered in the control phase R_R and ensures a decrease in the target torque MT.

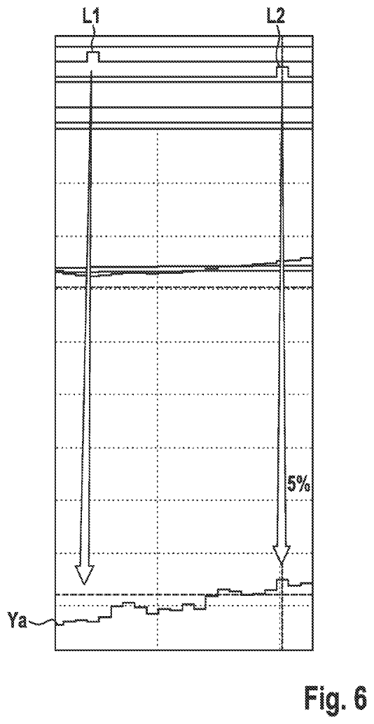

FIG. 6 is a schematic representation of a dynamic adaptation of the learning value. In this example, a first learning rule L1 is triggered and, later in time, a second learning rule L2 is triggered. At the time of triggering the first learning rule L1, the wheel acceleration Ya has a value of −2.75; at the time of triggering the second learning rule L2, the wheel acceleration Ya has a value of 1.5. A wheel acceleration Ya of −2.75 represents a medium deceleration of the axle. A learning value of 20% is accordingly applied instead of a learning value of 10%. In other words, due to the wheel acceleration Ya, a value of 20% is dynamically applied when adapting the parameters P of the value matrix M instead of an adaptation by the previously specified value of 10%. Likewise, a wheel acceleration Ya of 1.5 represents a slight acceleration of the axle, which is why a learning value of −15% is applied instead of a learning value of −10%. In this way, an amount of the learning value is dynamically adapted as a function of the wheel acceleration Ya.

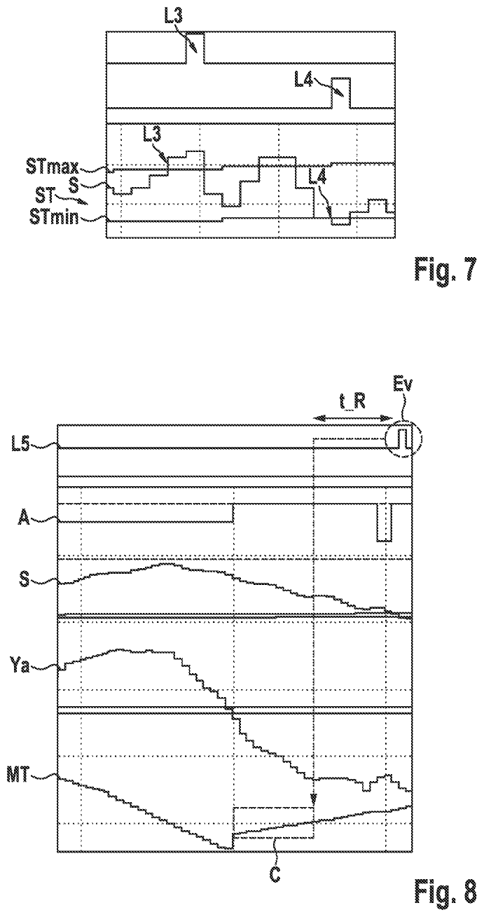

FIG. 7 is a schematic representation of an arbitration between two learning rules, in this case a third learning rule L3 and a fourth learning rule L4. The profiles of a slip S and of a target slip ST with a maximum limit value STmax and a minimum limit value STmin, in which the slip S is ideally to be located as a result of the traction control, are shown. In this case, two learning rules which work against one another are triggered in a comparatively short time period, e.g., 150 ms. The third learning rule L3 wants to increase the reduction in the slip since the slip is rising too much. The fourth learning rule L4 wants to decrease the reduction in the slip since the slip is falling too much.

In this respect, the two learning rules L3, L4 must be arbitrated. The arbitration comprises ignoring the earlier learning rule since the second learning rule has more current and/or more information. Alternatively, the arbitration comprises ignoring both learning rules. Alternatively, the arbitration comprises applying the temporally first learning rule only to a range that is further away from the triggering of the temporally second learning rule. Thus, the arbitration of the traction control allows different requirements for maneuvers and/or grounds to be taken into account.

FIG. 8 is a schematic representation of learning a response time t_R during the traction control. The representation shows a fifth learning rule L5, a control action A, a slip S, a wheel acceleration Ya, and a target torque MT over the time. The reason C for triggering the learning rule results here from the two state variables S and Ya. The resulting learning value range of the target torque is framed in yellow. FIG. 8 is intended to show that the length of the response time t_R between the actual reason C and an evaluation Ev by the learning rule L5 can have considerable influence. In this respect, it is advantageous for an optimized traction control if, as a function of an evaluation of the change in the state variables ΔS, a response time t_R is learned, in particular with the aid of a machine learning module.

1-10 (canceled)

11. A method for automatically adapting a traction control of a vehicle, comprising the following steps:
receiving current state variables of the vehicle, which each indicates a current state of the vehicle;
determining a control action using a traction controller based on the received current state variables, wherein the control action includes increasing, or maintaining, or decreasing a control variable, wherein the control variable includes a torque of a motor of the vehicle and/or a pressure of a brake cylinder of the vehicle;
determining a control gradient of the control variable using a value matrix, wherein the value matrix includes a plurality of parameters, which are each assigned to current value matrix state variables of the vehicle, wherein the control gradient (is selected from the plurality of parameters as a function of the current value matrix state variables, wherein the current state variables include the current value matrix state variables;
carrying out the traction control of the vehicle, wherein the control variable is adapted by the determined control gradient according to the determined control action;
determining a change in the current state variables as a result of carrying out the traction control over a considered time period; and
adapting at least one parameter of the value matrix as a function of the determined change in the current state variables by triggering at least one previously specified learning rule.

12. The method according to claim 11, wherein the current value matrix state variables of the vehicle include a slip and a wheel acceleration of the vehicle.

13. The method according to claim 11, wherein at least one learning rule in the considered time period is triggered by the determined change in the current state variables by a previously specified limit value, wherein the learning rule determines a learning value by which the at least one parameter is adapted.

14. The method according to claim 13, wherein the current value matrix state variables of the vehicle include a slip and a wheel acceleration of the vehicle, and wherein the learning value is adapted as a function of the wheel acceleration of the vehicle.

15. The method according to claim 13, wherein the at least one previously specified learning rule is selected from a plurality of learning rules, the learning rules include adjustment learning rules and control learning rules, wherein the adjustment learning rules are applied during an adjustment phase of the slip, and the control learning rules are applied during control after the adjustment phase of the slip.

16. The method according to claim 11, further comprising:
arbitrating at least two temporally successive learning rules when the at least two learning rules are triggered below a previously specified time interval between them.

17. The method according to claim 11, further comprising:
learning a response time between an evaluation of the change in the current state variables and the traction control.

18. The method according to claim 11, further comprising:
ignoring triggered learning rules as a function of the current state variables.

19. A non-transitory computer-readable storage medium on which is stored a computer program for automatically adapting a traction control of a vehicle, the computer program, when executed by a computer, causing the computer to perform the following steps:
receiving current state variables of the vehicle, which each indicates a current state of the vehicle;
determining a control action using a traction controller based on the received current state variables, wherein the control action includes increasing, or maintaining, or decreasing a control variable, wherein the control variable includes a torque of a motor of the vehicle and/or a pressure of a brake cylinder of the vehicle;
determining a control gradient of the control variable using a value matrix, wherein the value matrix includes a plurality of parameters, which are each assigned to current value matrix state variables of the vehicle, wherein the control gradient (is selected from the plurality of parameters as a function of the current value matrix state variables, wherein the current state variables include the current value matrix state variables;
carrying out the traction control of the vehicle, wherein the control variable is adapted by the determined control gradient according to the determined control action;
determining a change in the current state variables as a result of carrying out the traction control over a considered time period; and
adapting at least one parameter of the value matrix as a function of the determined change in the current state variables by triggering at least one previously specified learning rule.

20. A device configured to automatically adapt a traction control of a vehicle, the device configured to:
receive current state variables of the vehicle, which each indicates a current state of the vehicle;
determine a control action using a traction controller based on the received current state variables, wherein the control action includes increasing, or maintaining, or decreasing a control variable, wherein the control variable includes a torque of a motor of the vehicle and/or a pressure of a brake cylinder of the vehicle;
determine a control gradient of the control variable using a value matrix, wherein the value matrix includes a plurality of parameters, which are each assigned to current value matrix state variables of the vehicle, wherein the control gradient (is selected from the plurality of parameters as a function of the current value matrix state variables, wherein the current state variables include the current value matrix state variables;
carry out the traction control of the vehicle, wherein the control variable is adapted by the determined control gradient according to the determined control action;
determine a change in the current state variables as a result of carrying out the traction control over a considered time period; and
adapt at least one parameter of the value matrix as a function of the determined change in the current state variables by triggering at least one previously specified learning rule.
